(19) United States
(12) Patent Application Publication
(10) Pub. No.: US 2011/0028196 A1
(43) Pub. Date: Feb. 3, 2011

(54) METHOD FOR PROVIDING BALL INFORMATION IN SCREEN GOLF AND SYSTEM THEREFOR

(75) Inventor: Song Hwan Choi, Daejeon (KR)

Correspondence Address: LRK Patent Law Firm, 1952 Gallows Rd, Suite 200, Vienna, VA, 22182, US

(73) Assignee: RD-TEK CO., LTD., Daejeon (KR)

(21) Appl. No.: 12/921,583

(22) PCT Filed: Mar. 3, 2009
(86) PCT No.: PCT/KR09/01021

§ 371 Date: Sep. 9, 2010

(30) Foreign Application Priority Data
Mar. 13, 2008 (KR) 10-2008-0023106

(51) Int. Cl. A63F 13/00; A63F 13/12; A63F 9/24

(52) U.S. Cl. 463/3; 463/42; 463/43

(57) ABSTRACT

The present invention relates to a method and a system for providing ball information in screen golf to display not only the start/stop points of a ball but also the ball's route and the competition state in more detail. The invention comprises a wired/wireless terminal and a competition-results providing server. The wired/wireless terminal prepared in a place that provides a virtual golf course environment detects the coordinates and route of a ball depending on a golfer's shot and indicates the coordinates and the route on a stored map image according to preset conditions so that a golfer may confirm the ball's route and the competition state. In addition, the wired/wireless terminal transmits to the competition results server the competition information recognized during the golf competition with the correspondent golfer's information. The competition results server generates and provides the competition results requested by the golfer based on the competition information transmitted from the wired/wireless terminal. Since the invention indicates the start/stop points of a ball as well as the ball's route and the competition state in more detail, the golfer is able to enjoy a golf competition in a more realistic environment. Therefore, the invention enables the increase of pleasure in the golf competition.

### TECHNICAL FIELD

The present invention relates to a method and a system for providing ball information in screen golf, in more detail, a method and a system for providing ball information in screen golf to display not only the star/stop points of a ball but also the ball route and the competition state in more detail.

### BACKGROUND ART

Recently, a golf simulation technology using virtual reality has been developed and used to overcome the spatial limit of indoor driving ranges.

The technology is to measure kinetic data, such as the speed and flight angle of the golf ball in a predetermined space around the hitting stage and locates the golf ball on the basis of the data, and then output an image on a screen provided in front of the hitting stage.

The technology provides a golfer with a visual effect as if he/she plays golf in an actual field. The golf simulation system is commonly called ‘screen golf’, which provides an environment where golfers can play golf in a space with the screen golf for predetermined time after paying predetermined money, such as Norae-Bang.

However, the screen golf only show the total number of strokes while golf is in process under the golf rules set in a computer and does not output or store the ball routes corresponding to the total strokes and competition results. Therefore, it is impossible to provide the competition results after the competition is over, even if the players request the competition results.

### DISCLOSURE

### [Technical Problem]

The present invention has been made to overcome the problems and it is an object of the present invention to provide a method and a system for providing ball information in screen golf to display not only the start/stop points of a ball but also the ball route and the competition state in more detail.

Further, it is another object of the present invention to provide players with competition result information in addition to the ball routes that the players have hit, after the competition is over.

### [Technical Solution]

In order to accomplish the objects of the present invention, an aspect of the present invention provides a system for providing ball information in screen golf, and the system includes: wire/wireless terminals that are provided at a place where it can provide a field environment, using virtual reality, detect the coordinates and a ball route, when a player strokes, display the information on a pre-stored map image under preset conditions such that the player can see the competition state as well as the ball route, and transmit the competition information detected during a competition together with identification information of the player to a competition-results providing server; and the competition-results providing server that generates and provides competition result information requested by the player, on the basis of the competition result transmitted from the wire/wireless terminals.

Another aspect of the present invention provides a wire/wireless terminal that includes: a communication interface unit that performs wire/wireless communication through a wire/wireless communication network; a memory that stores information relating to the wire/wireless, terminal, including an image of a field; a golf environment setting unit that sets conditions for performing a golf competition as well as the player identification information and the field image, in accordance with the player's selection; a ball-coordinates detection unit detects the coordinates of a ball, when a golf competition starts; a shot information management unit that ascertains the start/stop points of the ball on the basis of the ball-coordinates detected by the ball-coordinate detection unit, constructs shot information together with the player identification information and correspondent competition-related information (state information), and then store and manage the information in the memory a map data generation unit that generates map data by reflecting the ball routes from the start of the competition to the current time into a pre-stored map image on the basis of the shot information; and an output unit that outputs a map image showing the competition state as well, as the ball routes which are generated by the map data generation unit, on a screen

It is preferable that the wire/wireless terminal further includes a shot information transmission unit that transmits the shot information generated by the shot information management unit to a competition-results providing server that manages golf game information collected from a plurality of wire/wireless terminals.

It is preferable that the map data generation unit includes: a reference point check unit that sets a tee box reference point and a hole cup reference point in a plan view and a stereoscopic view, and sets a limit of the map image by checking coordinates of the tee box reference point and coordinates of the hole cup reference point; a scale calculation unit that detects a position where the coordinates of the ball is displayed, on the basis of the scales of an entire map showing the whole sections of the field and a green map enlarging the surrounding of the hole cup; and an image generation unit that generates a map image to indicate the start point of the ball, the flight route of the ball, and the stop point of the ball on any one of the green map and the entire map, on the basis of the ball coordinates detected by the scaling calculation unit.

It is preferable that the scale calculation unit outputs the s′tart point of a ball, the flight route of a ball, and the stop point on the basis of the scale of the green map, when the distance from the current location of the ball to the hole cup is smaller than a predetermined reference value, or calculates the start point of the ball, the flight route of the ball, and stop point on the basis of the scale of the entire map, when the distance from the current location of the ball to the hole cup is larger than a predetermined reference value.

It is preferable that the correspondent competition-related information is environment information including geometric information, scores for each hit, and shot number information.

Another aspect of the present invention provides a competition-result providing server that includes: a communication interface unit that performs communication through a wire/wireless communication network; a database that stores information relating to the competition-results providing server; a condition setting unit that registers competition-results output conditions that are inputted by the player; a game information collection unit that collects competition information from a plurality of wire/wireless terminals, and stores and manages the information in the database; a map generation unit 240 extracts shot information of the output object requested by the player from the database and displays the location of a ball in a map image; and a output unit that outputs the map image generated by the map generation unit on a screen.

Another aspect of the present invention provides a method of providing the current screen golf competition state in a wire/wireless terminal, and the method includes: a) setting environment information of a golf competition, in accordance with selection of a player in a wire/wireless terminal; b) measuring start coordinates of a ball, when the golf competition starts in the wire/wireless terminal; c) measuring stop coordinates-of the ball and generating shot information including ball-coordinates information, player identification information, and competition state information, as the play strokes and the ball stops, in the wire/wireless terminal; and d) indicating competition information including the start point of the ball, the flight route of the ball, and the stop point of the ball on a map image, on the basis of the shot information generated in the step c), and outputting the information on a screen, in the wire/wireless terminal.

It is preferable that the step c) includes: measuring the stop coordinates of the ball in the wire/wireless terminal; generating shot information including the start coordinates of the ball, the stop coordinates of the ball, the player identification information, and the competition state information; adding the current number of shot to the number of shot measured from the start of the correspondent competition to the right before the current; and transmitting and storing the competition information in addition to the shot information to a competition-results providing server that manages the competition information collected from a plurality of wire/wireless terminals.

It is preferable that the step d) includes: d-1) setting a tee box reference point and a hole cup reference point in a plan view and a stereoscopic view, and setting the limit of a map image by checking coordinates of the tee box reference point and coordinates of the hole cup reference point, in the wire/wireless terminal; d-2) ascertaining whether the distance from the current location of the ball to the hole cup is smaller than a preset distance, when the repetition number of time that generates the map image is smaller than the number of shot, in the wire/wireless terminal; and d-3) estimating and indicating the start point of the ball, the flight route of the ball, and the stop point of the ball in a green map, on the basis of the scale of the green map, which enlarges the surrounding of the hole cup, when the distance from the current location of the ball to the hole cup is smaller than a preset distance, in the wire/wireless terminal, and estimating and indicating the start point of the ball, the flight route of the ball, and the stop point of the ball in the entire map, on the basis of the scale of an entire map, which shows the whole sections of a field, when the distance from the current location of the ball to the hole cup is larger than the preset distance, in the wire/wireless terminal.

Another aspect of the present invention provides a method of providing competition-results information on the basis of golf competition information collected from a plurality of wire/wireless terminals, in a competition-results providing server, and the method includes: a) collecting and storing competition information, including player identification information, start coordinates of a ball, and stop coordinates of the ball, which are transmitted from the wire/wireless terminals, in the competition-results providing server; b) registering competition result output conditions, including the player identification information and an output object, which are inputted by a player, in the competition-results providing server; c) extracting a competition result corresponding to the player identification information and the output object from the competition information collected and stored in the step a); and d) indicating and outputting the location of the ball in a map image, using the competition result extracted in the step c).

It is preferable that the output object is at least any one of a field size and a hole size, or combination of the sizes.

### [Advantageous Effects]

Since the method and the system for providing ball information in screen golf according to the present invention, as described above, displays the current competition state, including the ball route, as well as the start/stop positions of the ball in screen golf in more detail, the golfer is able to enjoy a golf competition in a more realistic environment, and accordingly, it is possible to increase pleasure in the golf competition.

Further, since the present invention can provide a player with competition-results information, including the ball routes according to strokes, it is possible to increase effect in practicing golf.

### DESCRIPTION OF DRAWINGS

FIG. 1 is a diagram illustrating the configuration of a system for providing ball information in screen golf according to the present invention;

FIG. 2 is a diagram illustrating the configuration of a wire/wireless terminal according to the present invention;

FIG. 3 is a view showing an example of a green map and the entire map according to the present invention;

FIG. 4 is a diagram illustrating the configuration of a map data generation unit according to the present invention;

FIG. 5 is a diagram illustrating the configuration of a competition-results providing server;

FIG. 6 is a flowchart illustrating an example, of a method of providing ball information according to the present invention;

FIG. 7 is a flowchart illustrating in detail a method of generating shot information according to the present invention;

FIG. 8 is a flowchart illustrating in detail a method of generating a map image according to the present invention; and

FIG. 9 is a flowchart illustrating a method of providing a competition result according to the present invention.

### REFERENCE NUMERALS

100: Wire/wireless terminal

110, 210: Communication interface unit

120: Golf environment setting unit

130: Ball-coordinates detection unit

140: Shot information management unit

150: Shot information transmission unit

160: Map data generation unit

161: Reference point check unit

163: Scale calculation unit

165: Image generation unit

170, 250: Output unit

180: Memory

200: Competition-results providing server

220: Condition setting unit

230: Game information collection unit

240: Map generation unit

260: Database

### BEST MODE

Hereinafter, preferred embodiments of the present invention are described in detail with reference to the accompanying drawings.

FIG. 1 is a diagram illustrating the configuration of a system for providing ball information in screen golf according to the present invention.

As shown in the figure, a system for providing ball information in screen golf includes wire/wireless terminals 100-a, 100-b, 100-c . . . (hereafter, indicated by '100) which are provided at a place where it can provide a field environment, using virtual reality, detect the coordinates and a ball route, when a player strokes, display the information on a pre-stored map image under preset conditions such that the player can see the competition state as well as the ball route, and transmit the competition information detected during a competition together with identification information of the player to a competition-results providing server 200, and the competition-results providing server 200 that generates and provides competition result information requested by the player, on the basis of the competition result transmitted from the wire/wireless terminals 100.

To be more specific, the wire/wireless terminal 100 is programmed to store images (including 2D-plan image and 3D-stereoscopic image) of the field such that the player can play golf in the virtual reality, and display the current competition state as well as the location of the ball and the score for each hitting on the pre-stored field image, as the game progresses. At least one of the wire/wireless terminal 100 is installed and connected with the competition-results providing sever 200 to transmit the competition result.

In this configuration, the wire/wireless terminal 100 stores a plurality of plan or stereoscopic field images and output field images selected by the player on specific screen.

For example, the field images include images of actual field, such as CJ Nine Bridges Country Club, Anyang Benest Golf Club, Jeju Country Club, Lake Side Country Club, Asiana Country Club, and Nambu Country Club, and images of virtual fields.

The competition-results providing server 200 is connected with the plurality of wire/wireless terminals 100 by a wire/wireless communication network and collects and stores competition information, including the player identification information, shot information, competition state information, from the wire/wireless terminals 100. In this configuration, the competition-results providing sever 200 stores the same field images as the field images stored I the wire/wireless terminals 100 to refer to when outputting the competition result.

Further, the competition-results providing server 200 can print out the competition result information through an output device (e.g. a printer etc.) that is separately provided, as well as-the output unit equipped therein.

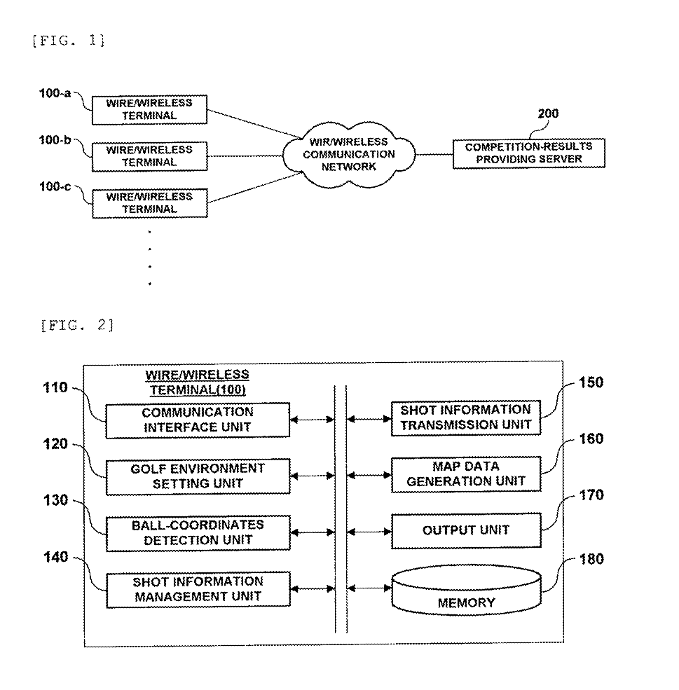

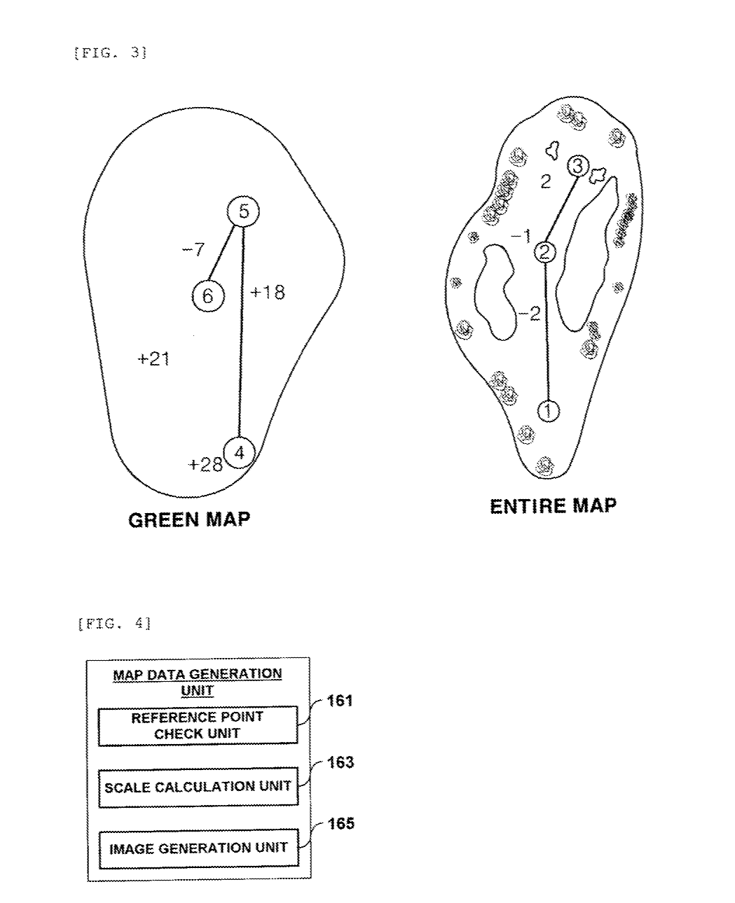

FIG. 2 is a diagram illustrating the configuration of a wire/wireless terminal according to the present invention, which is described with reference to FIG. 3 showing an example of the entire map and a green map.

As shown in the figure, the wire/wireless terminal 100 includes a communication interface unit 110 performing wire/wireless communication through a wire/wireless communication network, a golf environment setting unit 120, a ball-coordinates detection unit 130, a shot information management unit 140, a shot information transmission unit 150, a map data generation unit 160, an output unit 170, and a memory 180.

In more detail, the golf environment setting unit 120 sets conditions for performing a golf competition as well as the player identification information and the field image, in accordance with the player's selection.

The ball-coordinates detection unit 130 detects the coordinates of a ball, when a golf competition starts. In this configuration, the ball-coordinates detection unit 130 locates a ball by receiving the coordinates of the ball from sensors installed at several places in the indoor driving range, or more accurately estimates the location of the ball by substituting the coordinates measured by the sensors for preset conditions.

For example, the ball-coordinate detection unit 130 detects the start point of the ball before the player strokes and the coordinates of the ball that stops.

Further, the ball-coordinate detection unit 130 detects not only 2D-coordinates, but 3D-coordinates when detecting the coordinates of the ball to refer to the coordinates when display the location of the ball on a 3D-view.

The shot information management unit 140 ascertains the start/stop points of the ball on the basis of the ball-coordinates detected by the ball-coordinate detection unit 130, constructs shot information together with the player identification information and correspondent competition-related information (state information), and then store and manage the information in the memory 180. In this configuration, the correspondent competition-related information implies the environment information including geometric information, scores for each hit, and shot number information. The shot number increases one by one, as the player strokes.

The shot information transmission unit 150 transmits the shot information generated by the shot information management unit 140 to the competition-results providing server 200 that manages golf competition information collected from the wire/wireless terminals 100.

It is preferable that the shot information transmission unit 150 transmits the shot information to the competition-results providing server 200, after the player tries to stroke and balls stops, which cane be changed by the service operator.

The map data generation unit 160 generates map data by reflecting the ball routes from the start of the competition to the current time into a pre-stored map image on the basis of the shot information.

The map image, as shown in FIG. 3, is divided into the entire map showing the whole sections of the field and a green map enlarging the surrounding of the hole cup, in accordance with the display region, and the map data generation unit 160 displays location and a ball route in any one of the entire map and the green map. This is described in detail below.

The output unit 170 outputs a map image showing the competition state as well as the ball routes which are generated by the map data generation unit 160, on a screen.

The screen may be an independent screen or a screen equipped in the wire/wireless terminals 100.

The memory 180 stores information associated with the wire/wireless terminals 100 as well as the images of the field.

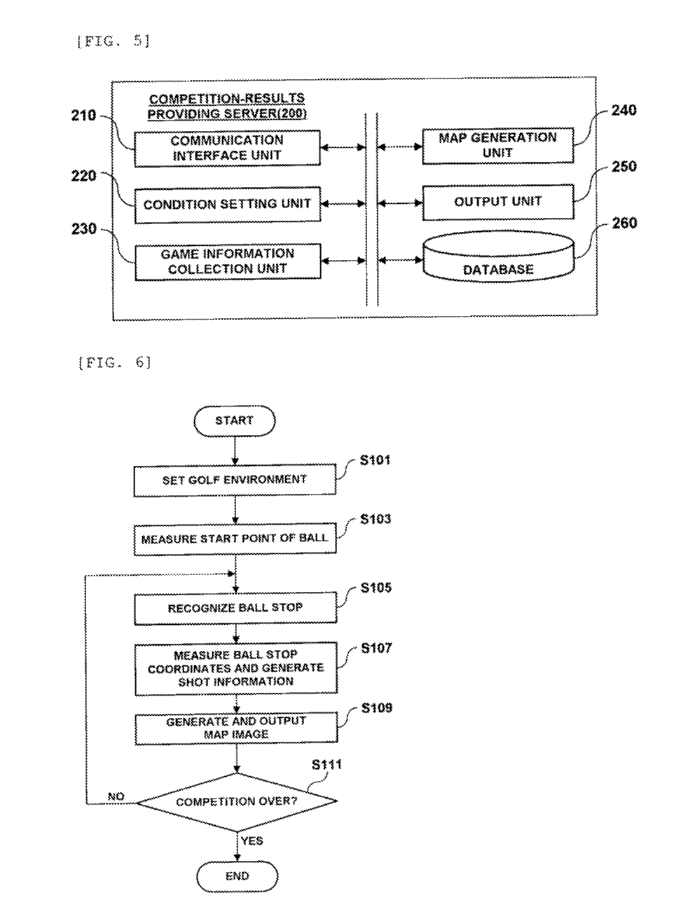

FIG. 4 is a diagram illustrating the configuration of a map data generation unit according to the present invention.

As shown in FIG. 4, the map data generation unit 160 includes a reference point check unit 161, a scale calculation unit 163, and image generation unit 165.

To be more specific, the reference point check unit 161 sets a tee box reference point and a hole cup reference point in a plan view and a stereoscopic view, and set the limit of the map image by checking the coordinates of the tee box reference point and coordinates of the hole cup reference point.

For example, the reference point check unit 161 sets the limits of plan (2D) map image and a stereoscopic (3D) image which are outputted to show the field.

The scale calculation unit 163 checks a position for showing the ball coordinates on the basis of the scales of the entire map showing the whole sections of the field and the green map enlarging the surrounding of the hole cup.

In this configuration, the scale calculation unit 163 outputs the start point of a ball, the flight route of a ball, and stop point on the basis of the scale of the green map, when the distance from the current location of the ball to the hole cup is smaller than a predetermined reference value, or calculates the start point of the ball, the flight route of the ball, and stop point on the basis of the scale of the entire map, when the distance from the current location of the ball to the hole cup is larger than a predetermined reference value.

The green map is a map image that shows in more detail the corresponding region, when the ball is located around the hole cup such that the player can easily recognize the states around the hole cup. This is because the player has difficult in seeing movement of ball, because the movement distance of the ball is small and the change corresponding to the movement route of the ball is too small to display on the entire map.

The image generation unit 165 generates a map image to indicate the start point of the ball, the flight route of the ball, and the stop point of the ball on any one of the green map and the entire map, on the basis of the ball coordinates detected by the scaling calculation unit 163.

In this configuration, the flight route of the ball is constructed by connecting the start point with the stop point of the ball, which may be displayed in consideration the environment (e.g. configuration of the ground, wind speed etc.) of the corresponding field (virtual field), in accordance with the conditions set by the operator.

Further, the image generation unit 165 indicates the entire movement route of the ball from the tee box point to the current point, when creating the map image.

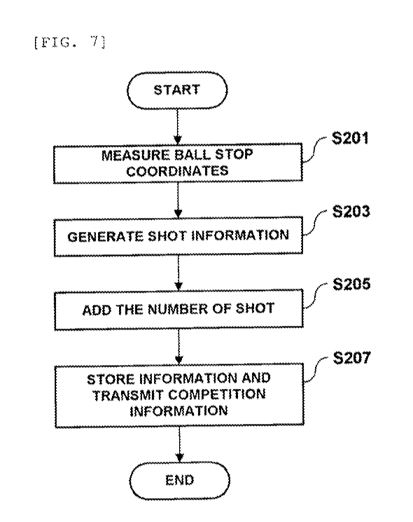

FIG. 5 is a diagram illustrating the configuration of a competition-results providing server.

As shown in FIG. 5, the competition-results providing server 200 includes a communication interface unit 210, a condition setting unit 220, a game information collection unit 230, a map generation unit 240, an output unit 250, and a database 260.

In more detail, the condition setting unit 220 registers competition result output conditions that are inputted by the player.

In this configuration, the competition result output conditions include the player identification information and an output object, and the output object is at least any one of the field size and-the hole size, or combination of them.

For example, when the player plays a golf competition in an image of ^{.}Jeju Country Club, the player requests the results of the entire competition made in Jeju Country Club, or only the competition result made in the 18-th hole of Jeju Country Club.

The game information collection unit 230 collects competition information from the wire/wireless terminals 100, and stores and manages the information in the database 260.

The map generation unit 240 extracts shot information of the output object requested by the player from the database 260 and displays the location of a ball in the map image.

The output unit 250 outputs the map image generated by the map generation unit 240 on the screen.

The database 260 stores information relating to the competition-results providing server 200.

FIG. 6 is a flowchart illustrating an example of a method for providing ball information according to the present invention, which exemplifies a method of providing the current screen golf competition state from the wire/wireless terminals.

First, the wire/wireless terminal 100 sets environment information of a golf competition, in accordance with selection of a player (S101).

The environment information of a golf competition is information for setting such that the player can play golf, for example, the player identification information and the field image.

Next, the wire/wireless terminal 100 measures the start coordinates of a ball, when the golf competition starts (S103).

As the player strokes and the ball stops, the wire/wireless terminal 100 measures the stop coordinates of the ball and generates shot information including the ball-coordinates information, the player identification information, and competition state information (S105, S107).

Thereafter, the wire/wireless terminal 100 indicates competition information including the start point of the ball, the flight route of the ball, and the stop point of the ball on the map image, on the basis of the shot information generated. in Step S107, and outputs the information on the screen (S109).

In this configuration, the flight route of the ball is constructed by connecting the start point with the stop point of the ball, which may be displayed in consideration the environment (e.g. configuration of the ground, wind speed etc.) of the corresponding field (virtual field), in accordance with the conditions set by the operator.

After the golf competition is over, the wire/wireless terminal 100 stops providing the current screen golf competition state, or if the golf competition is not over, performs the operation after Step S103 (S111).

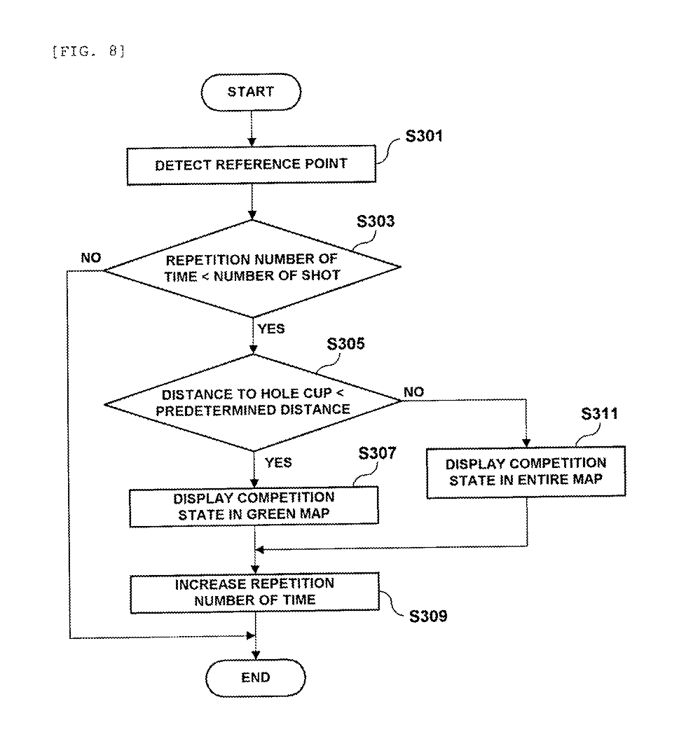

FIG. 7 is a flowchart illustrating in detail a method of generating shot information according to the present invention, and Step S107 of FIG. 6 is described in detail.

First, the wire/wireless terminal 100 measure the stop coordinates of the ball (S201).

In this process, the wire/wireless terminal measure the ball coordinates in a stereoscopic view as well as the ball coordinates in the plan view.

Next, the wire/wireless terminal 100 generates shot information including the start coordinates of the ball, the stop coordinates of the ball, the player identification information, and the competition state information (S203).

Thereafter, the wire/wireless terminal 100 adds the current number of shot to the number of shot measured from the start of the correspondent competition to the right before the current (S205).

Finally, the wire/wireless terminal 100 transmits the competition information in addition to the shot information to the competition-results providing server 200 that manages the competition information collected from the plurality of wire/wireless terminals, and stores the competition information in the memory 180 (S207).

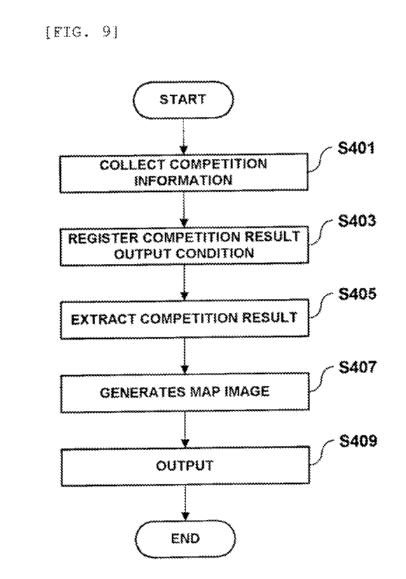

FIG. 8 is a flowchart illustrating in detail a method of generating a map image according to the present invention, and Step S109 of FIG. 6 is described in detail.

First, the wire/wireless terminal sets a tee box reference point and a hole cup reference point in a plan view and a stereoscopic view, and sets the limit of a map image by checking the coordinates of the tee box reference point and coordinates of the hole cup reference point (S301).

Next, the wire/wireless terminal 100 ascertains whether the distance from the current location of the ball to the hole cup is smaller than a preset distance, when the repetition number of time that generates the map image is smaller than the number of shot (S303, S305).

When the distance from the current location of the ball to the hole cup is smaller than the preset distance, as the result of Step S305, the wire/wireless terminal 100 estimates and indicates the start point of the ball, the flight route of the ball, and the stop point of the ball in the green map, on the basis of the scale of the green map, which enlarges the surrounding of the hole cup (S307).

Thereafter, the wire/wireless terminal 100 increases the repetition number of time by 1 (S309).

On the other hand, when the distance from the current location of the ball to the hole cup is larger than the preset distance, as the result of Step S305, the wire/wireless terminal 100 estimates and indicates the start point of the ball, the flight route of the ball, and the stop point of the ball in the entire map, On the basis of the scale of the entire map, which shows the whole sections of the field (S311).

Thereafter, the wire/wireless terminal 100 performs Step S309.

Further, when the repetition number of time is larger than the number of shot, as the result of Step S303, the wire/wireless terminal 100 stops generating the map image.

FIG. 9 is a flowchart illustrating a method of providing a competition result according to the present invention, in which it is exemplified when the competition-results providing server 200 provides competition result information on the basis of golf competition information collected from a plurality of wire/wireless terminals.

First, the competition-results providing server 200 collects and stores competition information, including the player identification information, the start coordinates of the ball, and the stop coordinates of the ball, which are transmitted from the plurality of wire/wireless terminals 100 (S401).

Next, the competition-results providing server 200 registers competition result output conditions, including the player identification information and the output object, which are inputted by the player (S403).

The output object is at least any one of the field size and the hole size, or combination of them.

The competition-results providing server 200 extracts a competition result corresponding to the player identification information and the output object from the competition information collected and stored in Step S401 (S405).

Thereafter, the competition-results providing server 200 indicates and outputs the location of the ball in the map image, using the competition result extracted in Step S405 (S407, S409).

It will be understood that those skilled in the art may implement the present invention in various ways without modifying the necessary feature or the scope of the present invention. Therefore, it should be noted that the embodiments described above are just examples and not limitative. The scope of the present invention is defined by the following claims, and all of modifications and changes from the meaning and scope defined by claims and equivalent conception should be construed as being included in the scope of the present invention.

1. A system for providing ball information in screen golf, the system comprising:
wire/wireless terminals that are provided at a place where it can provide a field environment, using virtual reality, detect the coordinates and a ball route, when a player strokes, display the information on a pre-stored map image under preset conditions such that the player can see the competition state as well as the ball route, and transmit the competition information detected during a competition together with identification information of the player to a competition-results providing server; and
the competition-results providing server that generates and provides competition result information requested by the player, on the basis of the competition result transmitted from the wire/wireless terminals.

2. A wire/wireless terminal comprising:
a communication interface unit that performs wire/wireless communication through a wire/wireless communication network;
a memory that stores information relating to the wire/wireless terminal, including an image of a field;
a golf environment setting unit that sets conditions for performing a golf competition as well as the player identification information and the field image, in accordance with the player's selection;
a ball-coordinates detection unit detects the coordinates of a ball, when a golf competition starts;
a shot information management unit that ascertains the start/stop points of the ball on the basis of the ball-coordinates detected by the ball-coordinate detection unit, constructs shot information together with the player identification information and correspondent competition-related information (state information), and then store and manage the information in the memory
a map data generation unit that generates map data by reflecting the ball routes from the start of the competition to the current time into a pre-stored map image on the basis of the shot information; and
an output unit that outputs a map image showing the competition state as well as the ball routes which are generated by the map data generation unit, on a screen.

3. The wire/wireless terminal according to claim 2, further comprising a shot information transmission unit that transmits the shot information generated by the shot information management unit to a competition-results providing server that manages golf game information collected from a plurality of wire/wireless terminals.

4. The wire/wireless terminal according to claim 2, wherein the map data generation unit includes:
a reference point check unit that sets a tee ,box reference point and a hole cup reference point in a plan view and a stereoscopic view, and sets a limit of the map image by checking coordinates of the tee box reference point and coordinates of the hole cup reference point;
a scale calculation unit that detects a position where the coordinates of the ball is displayed, on the basis of the scales of an entire map showing the whole sections of the field and a green map enlarging the surrounding of the hole cup; and
an image generation unit that generates a map image to indicate the start point of the ball, the flight route of the ball, and the stop point of the ball on any one of the green map and the entire map, on the basis of the ball coordinates detected by the scaling calculation unit.

5. The wire/wireless terminal according to claim 4, wherein the scale calculation unit outputs the start point of a ball, the flight route of a ball, and the stop point on the basis of the scale of the green map, when the distance from the current location of the ball to the hole cup is smaller than a predetermined reference value, or calculates the start point of the ball, the flight route of the ball, and stop point on the basis of the scale of the entire map, when the distance from the current location of the ball to the hole cup is larger than a predetermined reference value.

6. The wire/wireless terminal according to claim 2, wherein the correspondent competition-related information is environment information including geometric information, scores for each hit, and shot number information.

7. A competition-result providing server comprising:
a communication interface unit that performs communication through a wire/wireless communication network;
a database that stores information relating to the competition-results providing server;
a condition setting unit that registers competition result output conditions that are inputted by the player;
a game information collection unit that collects competition information from a plurality of wire/wireless terminals, and stores and manages the information in the database;
a map generation unit extracts shot information of the output object requested by the player from the database and displays the location of a ball in a map image; and
an output unit that outputs the map image generated by the map generation unit on a screen.

8. A method of providing ball information in screen golf, which provides the current screen golf competition state in a wire/wireless terminal, the method comprising:
a) setting environment information of a golf competition, in accordance with selection of a player in a wire/wireless terminal;
b) measuring start coordinates of a ball, when the golf competition starts in the wire/wireless terminal;
c) measuring stop coordinates of the ball and generating shot information including ball-coordinates information, player identification information, and competition state information, as the player strokes and the ball stops, in the wire/wireless terminal; and
d) indicating competition information including the start point of the ball, the flight route of the ball, and the stop point of the ball on a map image, on the basis of the shot information generated in the step c), and outputting the information on a screen, in the wire/wireless terminal.

9. The method of providing ball information in screen golf according to claim 8, wherein the step c) includes:
measuring the stop coordinates of the ball in the wire/wireless terminal;
generating shot information including the start coordinates of the ball, the stop coordinates of the ball, the player identification information, and the competition state information;
adding the current number of shot to the number of shot measured from the start of the correspondent competition to the right before the current; and
transmitting and storing the competition information in addition to the shot information to a competition-results providing server that manages the competition information collected from a plurality of wire/wireless terminals.

10. The method of providing ball information in screen golf according to claim 8, wherein the step d) includes:
d-1) setting a tee box reference point and a hole cup reference point in a plan view and a stereoscopic view, and setting the limit of a map image by checking coordinates of the tee box reference point and coordinates of the hole cup reference point, in the wire/wireless terminal;
d-2) ascertaining whether the distance from the current location of the ball to the hole cup is smaller than a preset distance, when the repetition number of time that generates the map image is smaller than the number of shot, in the wire/wireless terminal; and
d-3) estimating and indicating the start point of the ball, the flight route of the ball, and the stop point of the ball in a green map, on the basis of the scale of the green map, which enlarges the surrounding of the hole cup, when the distance from the current location of the ball to the hole cup is smaller than a preset distance, in the wire/wireless terminal, and
estimating and indicating the start point of the ball, the flight route of the ball, and the stop point of the ball in the entire map, on the basis of the scale of an entire map, which shows the whole sections of a field, when the distance from the current location of the ball to the hole cup is larger than the preset distance, in the wire/wireless terminal.

11. A method of providing ball information in screen golf, which provides competition result information on the basis of golf competition information collected from a plurality of wire/wireless terminals, in a competition-results providing server, the method comprising:
a) collecting and storing competition information, including player identification information, start coordinates of a ball, and stop coordinates of the ball, which are transmitted from the wire/wireless terminals, in the competition-results providing server;
b) registering competition result output conditions, including the player identification information and an output object, which are inputted by a player, in the competition-results providing server;
c) extracting a competition result corresponding to the player identification information and the output object from the competition information collected and stored in the step a); and
d) indicating and outputting the location of the ball in a map image, using the competition result extracted in the step c).

12. The method of providing ball information in screen golf according to claim 11, wherein the output object is at least any one of a field size and a hole size, or combination of the sizes.

13. The wire/wireless terminal according to claim 3, wherein the correspondent competition-related information is environment information including geometric information, scores for each hit, and shot number information.

14. The wire/wireless terminal according to claim 4, wherein the correspondent competition-related information is environment information including geometric information, scores for each hit, and shot number information.

15. The wire/wireless terminal according to claim 5, wherein the correspondent competition-related information is environment information including geometric information, scores for each hit, and shot number information.

16. The method of providing ball information in screen golf according to claim 9, wherein the step d) includes:
d-1) setting a tee box reference point and a hole cup reference point in a plan view and a stereoscopic view, and setting the limit of a map image by checking coordinates of the tee box reference point and coordinates of the hole cup reference point, in the wire/wireless terminal;
d-2) ascertaining whether the distance from the current location of the ball to the hole cup is smaller than a preset distance, when the repetition number of time that generates the map image is smaller than the number of shot, in the wire/wireless terminal; and
d-3) estimating and indicating the start point of the ball, the flight route of the ball, and the stop point of the ball in a green map, on the basis of the scale of the green map, which enlarges the surrounding of the hole cup, when the distance from the current location of the ball to the hole cup is smaller than a preset distance, in the wire/wireless terminal, and
estimating and indicating the start point of the ball, the flight route of the ball, and the stop point of the ball in the entire map, on the basis of the scale of an entire map, which shows the whole sections of a field, when the distance from the current location of the ball to the hole cup is larger than the preset distance, in the wire/wireless terminal.
